(19) United States
(12) Patent Application Publication
(10) Pub. No.: US 2015/0047044 A1
(43) Pub. Date: Feb. 12, 2015

(54) SYSTEM AND METHODS FOR PROTECTING AND USING DIGITAL DATA

(71) Applicant: MEDKNEX SOFTWARE, LLC, Los Angeles, CA (US)

(72) Inventors: William B. Townsend, Sherman Oaks, CA (US); James D. Somes, Los Angeles, CA (US); John VanZandt, Mission Viejo, CA (US)

(21) Appl. No.: 14/453,588

(22) Filed: Aug. 6, 2014

Related U.S. Application Data
(60) Provisional application No. 61/862,790, filed on Aug. 6, 2013.

(51) Int. Cl. G06F 21/57; G06F 21/60; G06F 21/56

(52) U.S. Cl. CPC G06F 21/577; G06F 21/562; G06F 21/60
USPC 726/24; 726/23

(57) ABSTRACT

Embodiments of the invention include a computer-implemented method of securing data transfer to a computing device by accessing a secure data transfer module and performing a security threat assessment of the hardware and software of the device by scanning for a security threat. The security threat can include absence of antivirus software, presence of unapproved antivirus software, out-of-date virus definitions, presence of a malicious software code, and an operating system of the computing device that has been modified, or has not received recent operating system updates, or threats related to digital content. Moreover, the computer-implemented method includes using a processor of the computing device to access a secure data transfer module to process a secure data transfer to the computing device in the absence of any security threats. Embodiments also include a removeable non-transitory computer-readable storage device for storing and executing files for the computer-implemented method within a computing device.

### BACKGROUND

Computer device security can be dependent on a variety of technology and human related factors. For example, some users may fail to properly protect and physically secure their devices, and they may fail to use adequately secure system passwords. Individuals and corporations are increasingly accessing, downloading, uploading, storing, and using data from multiple devices in multiple formats with outdated security protocols.

Many security protocols are passive, designed to protect a device while ignoring the hacking device. Furthermore, user data and content (some of which includes highly valuable and sensitive information such as credit card, debit card, bank transactions and medical records) is migrating to cloud servers hosting databases accessible only through an internet connection. The client's internet connection may harbor a variety of hardware and software vulnerabilities which may include one or more design flaws, or may be made more vulnerable by an external virus or through a user-defined setting.

### SUMMARY

Embodiments of the invention include a computer-implemented method of securing data transfer to a computing device comprising using at least one processor of a computing device, accessing a secure data transfer module and performing a security threat assessment of the hardware and software of the computing device by performing steps of the method. The steps include scanning for the presence of a security threat comprising the absence of antivirus software, or the presence of unapproved antivirus software stored in a non-transitory computer-readable medium. The steps also include scanning for the presence of a security threat comprising out-of-date virus definitions within any one file associated with any approved antivirus software residing on the non-transitory computer-readable medium. The steps include scanning for the presence of a security threat comprising a malicious software code residing on non-transitory computer-readable media coupled to the computing device. The steps also include scanning for the presence of security threat comprising an operating system of the computing device that has been modified, or has not received recent operating system updates. Further, the steps include scanning for the presence of a security threat related to digital content. Moreover, the computer-implemented method includes using at least one processor of the computing device to access a secure data transfer module to process a secure data transfer to the computing device in the absence of any identified security threats determined by the computer-implemented method.

In some embodiments of the computer-implemented method, the malicious software code comprises at least one of a virus or malware. In some further embodiments, the malicious software code comprises potentially unsafe software. In some embodiments, any identified malicious code is modified by the secure data transfer module using the at least one processor. In some further embodiments, any identified malicious code is erased by the secure data transfer module using the at least one processor. In some embodiments of the invention, potentially unsafe software comprises an operating system of the computing device. In some further embodiments, potentially unsafe software comprises at least one software module accessible and operable by the at least one processor.

Some embodiments of the invention include a non-transitory computer-readable medium that includes at least one of a hard-drive, a solid-state drive, a CD/DVD drive, a random-access-memory device, a remote device drive, or a cloud-based drive. In some embodiments, the secure data transfer module is stored on a non-transitory storage medium. In some embodiments, the secure data transfer module is uploaded to the computing device, and the secure data transfer module is run by the at least one processor of the computing device.

In some embodiments, the security threat related to digital content includes any applications that are potentially harmful to digital content. In some embodiments, the security threat related to digital content includes a modified digital content within the computing device. In some further embodiments, the security threat related to digital content includes the computer device comprising at least one application configured to run and/or play unoriginal and unlicensed versions of the digital content.

In some embodiments, the secure data transfer includes at least one video. In some further embodiments, the secure data transfer module and the at least one video are accessed from the same device or location.

Some embodiments of the computer-implemented method comprise the at least one processor accessing a secure data transfer server prior to performing a security threat assessment or processing a secure data transfer to the computing device. In some embodiments, the secure data transfer server transfers security threat information to the computing device and the secure data transfer module, and any video player controlled by the at least one processor is validated for display of information by the secure data transfer module.

In some embodiments, the secure data transfer module requests a password from the user to initiate the secure data transfer, and the secure data transfer comprises data decryption. In some embodiments, the user is provided with a choice of data to be transferred after secure data transfer is initiated.

Some embodiments include a removeable non-transitory computer-readable storage device for storing and executing files transferred from the removeable non-transitory computer-readable storage device to a computing device. The removeable non-transitory computer-readable storage device comprises a non-transitory computer-readable storage medium comprising instructions for providing a secure data transfer to a computing device, where the instructions, when executed by at least one processor of the device, configure the at least one processor to access a secure data transfer module and perform a security threat assessment of the hardware and software of the computing device by performing various steps. The steps including scanning for the presence of a security threat comprising the absence of antivirus software or the presence of unapproved antivirus software stored in a non-transitory computer-readable medium. The steps also include scanning for the presence of a security threat comprising out-of-date virus definitions within any one file associated with any approved antivirus software residing on the non-transitory computer-readable medium. Further, the steps include scanning for the presence of a security threat comprising a malicious software code residing on non-transitory computer-readable media coupled to the computing device. The steps include scanning for the presence of security threat comprising an operating system of the computing device that has been modified or has not received recent operating system updates. The steps include scanning for the presence of a security threat related to digital content, and using at least one processor of the computing device, accessing a secure data transfer module to process a secure data transfer to the computing device in the absence of any identified security threats determined by the steps of the security threat assessment.

### DESCRIPTION OF THE DRAWINGS

FIG. 1 is a block diagram illustrating insertion and operation of the scout application within a hardware device in accordance with at least one embodiment of the invention.

FIG. 2 shows one example of system architecture capable of implementation of at least one method implemented by at least one scout application according to one embodiment of the invention.

FIG. 3A shows a flow chart diagram illustrating system operation methods performed by a scout application within a hardware device in accordance with at least one embodiment of the invention.

FIG. 3B shows a flow chart diagram illustrating user implemented system operation methods performed by a scout application within a hardware device in accordance with at least one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention described herein relate to systems and methods to protect digital data, aggregating either user-generated digital data, or searching and copying digital data across hardware devices and through the internet. In some embodiments, the methods and systems can be implemented on many different types of processing devices by program code comprising program instructions that are executable by the device processing subsystem. The software program instructions can include source code, object code, machine code, or any other stored data that is operable to cause a processing system to perform the methods and operations described herein. Other implementations can also be used, however, such as firmware or even appropriately designed hardware configured to carry out the methods and systems described herein. For example, a computer can be programmed with instructions to perform the various steps of the operations shown in the figures. The software program instructions can be developed into a software application to work on many different types of computer-readable media including computer storage mechanisms (e.g., CD-ROM, DVD, diskette, RAM, flash memory, computer's hard drive, computer tablets, mobile phones, gaming devices, SSD Cards and Micro-SSD cards, and computer servers as a cloud application, etc.), that contains instructions (e.g., software) for use in execution by a processor to perform the methods' operations and implement the systems described herein.

Some embodiments of the invention can include at least one software module comprising at least one software application (hereinafter referred to as the scout application 101). In some embodiments, the scout application 101 can comprise numerous individually coupled software applications and/or firmware applications. Some embodiments of the invention can include at least one scout application 101 capable of enabling the protection of digital data, aggregating either user-generated digital data, or searching and copying digital data across hardware devices and through the internet.

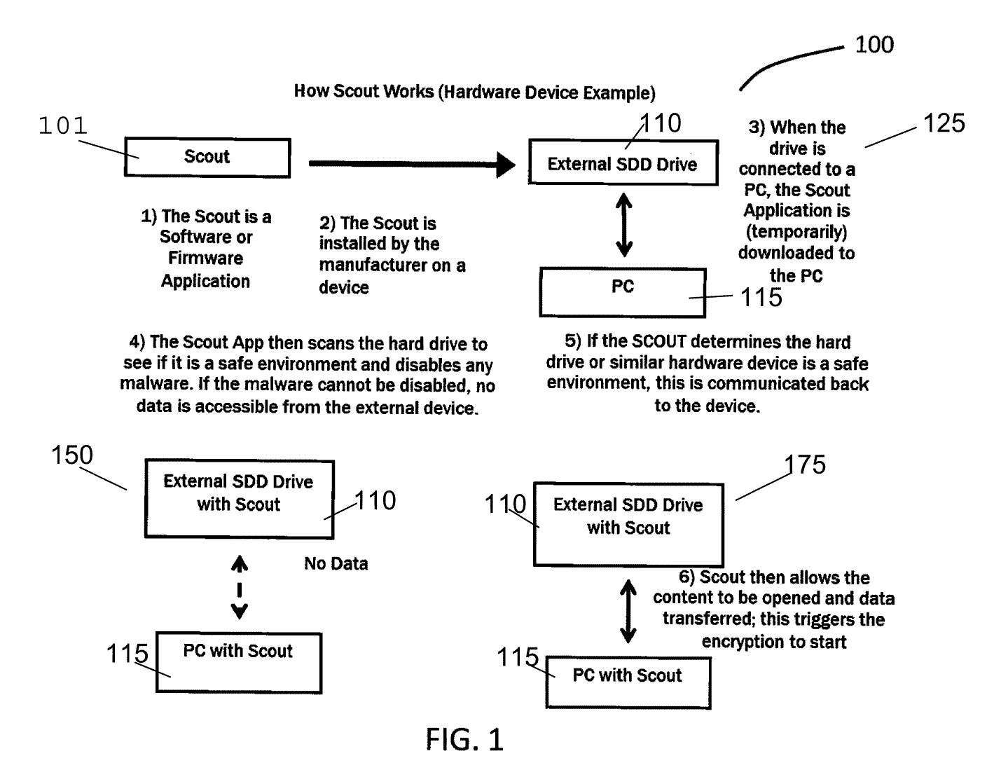

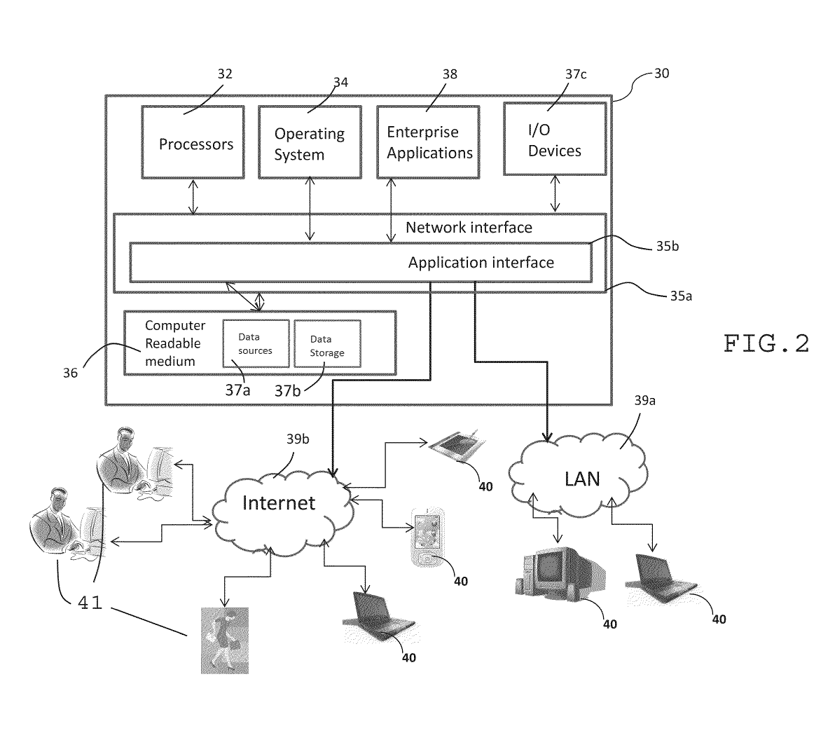

In some embodiments, a pre-installed device driver can communicate to the device when the device is coupled to a computer and download configuration information to run a scout application 101 (which is already part of the device driver). For example, FIG. 1 is a block diagram illustrating insertion and operation of the scout application 101 within a hardware device in accordance with at least one embodiment of the invention (process step 125). In some embodiments, a scout application 101 can comprise software or firmware applications. In some embodiments, the scout application 101 is installed by the manufacturer on a device (such as a computer and/or a non-transitory computer readable device within, or capable of being coupled to the computer). For example, in some embodiments, a scout application 101 can be pre-loaded to a non-transitory computer readable device such as an external SDD drive 110. In some embodiments, after the SDD drive 110 is coupled to a computer, a scout application 101 can be downloaded to the computer 115. In some embodiments, the computer 115 can comprise a computer system 30 and/or a computer 40 (shown in FIG. 2). In some embodiments, the scout application 101 download is temporary (i.e., the portion of the scout application 101 downloaded will expire and/or will later remove itself from the computer 115).

In some other embodiments, one or more scout applications 101 can be uploaded to a user 41 device over a network (e.g., by downloading from the internet). In some embodiments, once the user device (such as computer 115) is coupled to a network, a scout application 101 can be downloaded and installed onto the device. In some embodiments, a scout application 101 can load onto a user's device with user 41 permission. In other embodiments, a scout application 101 can load onto a user's device without user 41 permission.

In some further embodiments, a permanently loaded or temporary scout application 101 can be upgraded. For example, in some embodiments, an installed version of a scout application 101 can be modified and/or replaced by an upgraded version. In some embodiments, the scout application 101 can be upgraded in real-time when the user's device is connected to the internet, whereas in other embodiments, the scout application 101 can be ungraded from an external memory or drive.

In some embodiments, the scout application 101 can perform a scan of at least one internal memory device on the computer 115. For example, in some embodiments, the scout application 101 can scan any non-transitory computer readable medium 36 coupled to the computer 115. For example, in some embodiments, the scout application 101 can scan any hard disk drive or solid-state drive to ascertain if the drive is a safe environment. In some embodiments, the scout application 101 can scan a hard disk drive or solid-state drive and disable any existing malware or the potentially unsafe software. As depicted, in some embodiments, if the scout application 101 determines the malware or other unsafe software cannot be disabled, no data is accessible from the external device (in process 150).

In some embodiments, if the scout application 101 determines the hard drive or similar hardware device is a safe environment, the scout application 101 can communicate this finding back to the device. In some embodiments, the scout application 101 can then allow data content to be accessed within the external SDD drive, and data encryption and data transfer can be initiated (depicted in process 175).

FIG. 2 shows one example of computer system 30 capable of implementation of at least one method implemented by at least one scout application 101 according to one embodiment of the invention. For example, in some embodiments, the scout application 101 can access and couple to the computer system 30. Moreover, in some embodiments, at least a portion of the scout application can be run by the computer system 30. As depicted in FIG. 2, in at least one embodiment of the invention, the software modules can form part of a computer system 30, (for example a network server-based processing platform). In some embodiments, the system 30 can include at least one computing device, including at least one or more processors 32. Some processors can include processors residing in one or more server platforms. The system 30 can include a network interface 35a and an application interface 35b coupled to a plurality of processors 32 running at least one operating system (e.g., enterprise applications 38). In some embodiments, the applications 38 can be coupled to at least one non-transitory computer readable medium 36 that can comprise at least one data storage device 36, a plurality of data sources 37a. Further, in some embodiments, the applications 38 can be coupled to at least one input/output device 37c.

In some embodiments, one or more of scout application 101 can be coupled to at least one data source 37a and/or data storage system 37b coupled to the computer system 30. The scout application 101 can be configured to send and receive data from a database (including for example the non-transitory computer readable medium 36), and data can be received by the modules from at least one other source. In some embodiments, at least one of the scout application 101 can be configured within the system to output data to a user 41 (via at least one digital display). In some embodiments, at least one of the software modules 38 can be configured within the system to output data to a user 41 via at least one digital display (e.g., to a computer 40 comprising a digital display). In some embodiments, one or more components of the network 39a, 39b can include a number of client devices which can be computers 40 including for example desktop computers, laptop computers, digital assistants, personal digital assistants, cellular phones, mobile phones, smart phones, pagers, digital tablets, internet appliances, and other processor-based devices. In general, a client device can be any type of external or internal devices such as a mouse, a CD-ROM, DVD, a keyboard, a display, or other input or output devices 37c.

In some embodiments, the system 30 as described can enable one or more user's computers 40 to receive and send data to and from the system 30, including to and from one or more enterprise applications 38 running on the system 30. Some embodiments include at least one user's computer 40 accessing one or more modules 10, including at least one enterprise applications 38 via a stationary I/O device 37c through a LAN 39a. In some other embodiments, the system 30 can enable at least one user's computer 40 accessing enterprise applications 38 via a stationary or mobile I/O device 37c through an internet 39a.

Some embodiments of the invention can be deployed across various hardware and software platforms. In some embodiments, one or more of scout application 101 can be operatively coupled to at least one server-platform. For example, in some embodiments, one or more scout applications 101 can be coupled to at least one data source and/or data storage system or conventional remote storage device coupled to a server. In some embodiments, the computer system 30 can be a server, coupled to one or more user's 41 with access to a computing device. In some embodiments, the one or more of scout application 101 can be configured to send and receive data from the database, and data can be received by the one or more of scout application 101 from at least one other source. In some embodiments, the hardware platform can comprise any one or more of the user 41 devices. For example, in some embodiments, any user 41 device can include a computing device 40 including personal computers, digital assistants, personal digital assistants, cellular phones, mobile phones, smart phones, pagers, digital tablets, laptop computers, internet appliances, and other processor-based devices. In some embodiments, the user 41 can interact with the user interface and be directed to at least one other digital display or other user interface. In some embodiments, one or more scout applications 101 can be configured to operate on devices running Microsoft Windows operating system (e.g., Windows® 7 and Windows® 8 operating system or future versions of any of the afore-mentioned), an Apple operating system or an Android operating system. Linux®, Microsoft® and Windows® are either registered trademarks or trademarks of Microsoft Corporation in the United States and/or other countries. Apple® is either a registered trademark or trademark of Apple Computer, Inc. in the United States and/or other countries. Android® is a trademark of Google Inc.

Some embodiments of the invention can include scout application 101 that are readily interfaced and integrated into mobile operating environments, including, but not limited to, an Android operating system, or an Apple® iPhone operating system, Nokia Symbian operating system, and Microsoft® Windows Mobile operating system. Android® is a registered trademark of Google Inc. Symbian® is a registered trademark of Symbian Ltd.

Some embodiments of the invention can include scout application 101 that are readily interfaced and integrated into web enabled platforms. In some embodiments, one or more scout applications 101 can be operatively coupled to a device running at least one web browser, including, but not limited to Microsoft® Internet Explorer, Netscape, Apple® Safari, Mozilla Firefox, and Opera.

Netscape® and Netscape Navigator® are registered trademarks of Netscape Communications Corporation in the United States and other countries.

Apple®, Safari®, Mac®, Macintosh®, and Power Macintosh® are trademarks of Apple Computer, Inc., registered in the United States and other countries.

Mozilla®, the Mozilla® logo, Firefox® and the Firefox® logo are trademarks of The Mozilla Foundation and registered in the United States and other countries.

Opera and Opera Mini are trademarks of Opera Software ASA registered in the United States and other countries, and used under license.

Some embodiments of the invention include protecting digital data and systems. For example, in some embodiments, one or more software modules and/or portions of the scout application 101 operating in a computing system 30 can be configured to protect digital data by having at least a portion of the scout application 101 installed in a host server that hosts digital data content, or assists another server that hosts the digital data content (e.g., an assisting server). In some embodiments, where the scout application 101 is installed in a host server, a client (digital data content client or customer) can request a specific piece of digital data/content from the host server in a commercial transaction. Upon confirmation of the commercial transaction compensation, the digital data content package can be sent in an encrypted format with a scout application 101 as part of the package. In some embodiments, the scout application 101 can be installed from a hardware device, over a network or a combination of both.

In further embodiments, one or more scout applications 101 can be configured to perform a protecting function. For example, in some embodiments, one or more scout applications 101 can be configured to protect digital data content by having a scout application 101 installed on a hardware device (e.g., as firmware), including any portion of a computer system 30 and/or any other user 41 device such as a computer 40 that can be operatively coupled to the computer system 30. In some embodiments, the scout application 101 is linked with commercial anti-virus software programs (or similar site and content protection software including of digital asset management software). According to this embodiment, the linked scout application 101 can scan, review, confirm and communicate the status of viewer and content handling programs and software on client/viewer hardware.

In some embodiments, the scout application 101 can search and review hardware and/or software functionality to confirm if the viewer and content handling program/software on client/viewer target device is valid and up to date. In some embodiments, this can indicate if the device is protected and safe for scout related content to be downloaded and decrypted.

In some alternative embodiments, a scout application 101 can confirm if the viewer and content handling software is authorized for that viewer and the user's device. In some embodiments, the decryption can be done either on the sender or on the receiver. If on the receiver, then key information is also transmitted to the receiver.

In some embodiments, after the device is scanned (e.g., a computer system 30 and/or a user's computer 40), the application confirms the date and/or the validity of the last versions of the content related software. In some embodiments, the scout application 101 reports back to the sender. In some embodiments, if the scan and application confirmation are positive, encrypted content is either sent (if the target content is resident on another external server) or unlocked and unencrypted (if a memory device, such as a flash memory storage device is being used) for either or both the target content and the scout application 101 (for scout application 101 related content). In some embodiments, it is also possible that the target content is encrypted uniquely for each receiving computer 30, 40 and then sent to the receiver.

In some embodiments, various encryption software configurations can be used to protect the target content. In some embodiments, these can include various proprietary or commercial encryption software programs. In some embodiments, they can include a rotating encryption scheme that is then deployed when the target content is being transmitted.

In some embodiments, a system 30 can be configured with a shield such that when a device is hacked, any file that the hacker is attempting to read will turn into a digital imaging and communications in medicine (“DICOM”) or other high density formatted file which is very slow to upload. In some embodiments, subsequently, the system 30 will also place a warning placard on the device screen (when applicable) stating that a hack is occurring and/or with a scout telling the hacking machine to cease hacking.

In some embodiments, a system 30 can be configured with a shield such that when a device is hacked, a scout application 101 will be transmitted to the hacking source of origin and will convert at least one or more files into DICOM (or other high density) formatted file on the hacker's computing device.

In some embodiments, a system 30 can be configured with a shield such that when a device is hacked a scout will be transmitted to the hacking source of origin and will tell the computer to change its electricity format from its current setting to any other setting (e.g., a USA 120V would be switched to UK 220V). In some embodiments, this action can cause the hacking device to become permanently inoperable if it is plugged into an electrical outlet.

Some embodiments include methods for protecting and permission data retention. For example, in some embodiments, a client/target viewer will have the option to back-up and store legal and authorized content to the scout application 101 server. In addition, the client/target viewer can back up/store the primary and/or secondary passwords to the above mentioned scout related content.

Some embodiments include a system and method configured to have the scout application 101 review, collate and timely distribute digital data receipts on a permission opt-in basis. For example, in some embodiments, digital data receipts from different single user 41 representative classes of information can be distributed by encrypting each data receipt using an encryption method under the control of the user 41, routed to a storage facility (e.g., a scout application 101 server) so as to aggregate the encrypted data receipts associated with the user 41.

Some embodiments include a system and method configured to have the scout application 101 search and copy digital data from at least one hardware device to at least one other hardware device through the internet. For example, in some embodiments, a scout application 101 can search and copy digital data from a system 30 to at least one other hardware device such as a user's computer 40 through the internet. In some embodiments, a scout application 101 can encrypt each data receipt using an encryption method under the control of the system designer, and route each encrypted data receipt to a storage facility and aggregate the encrypted data.

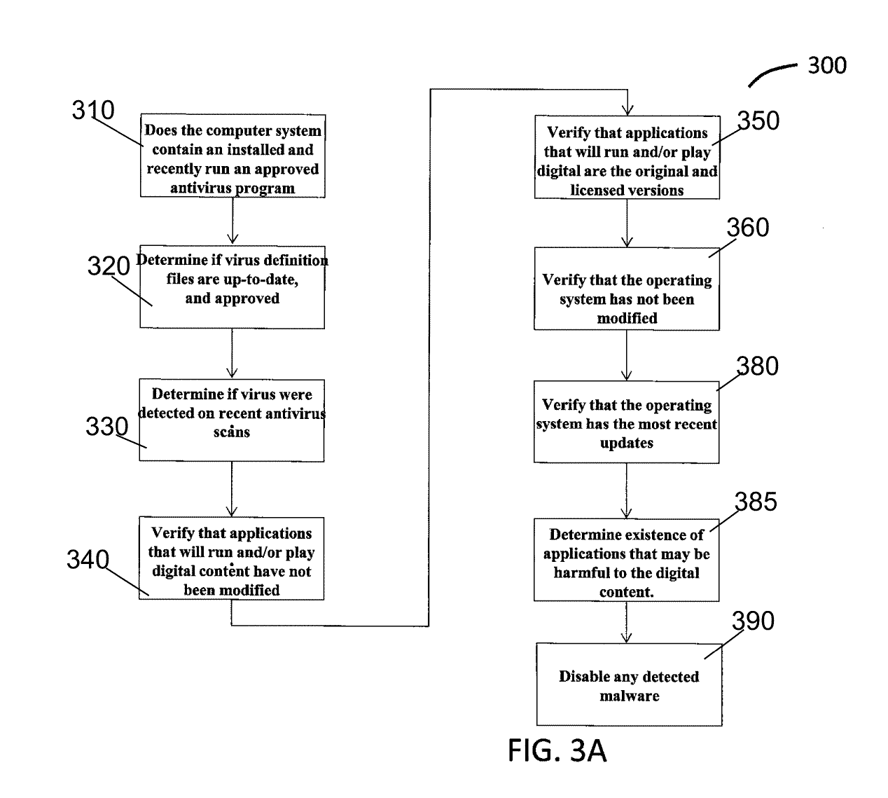

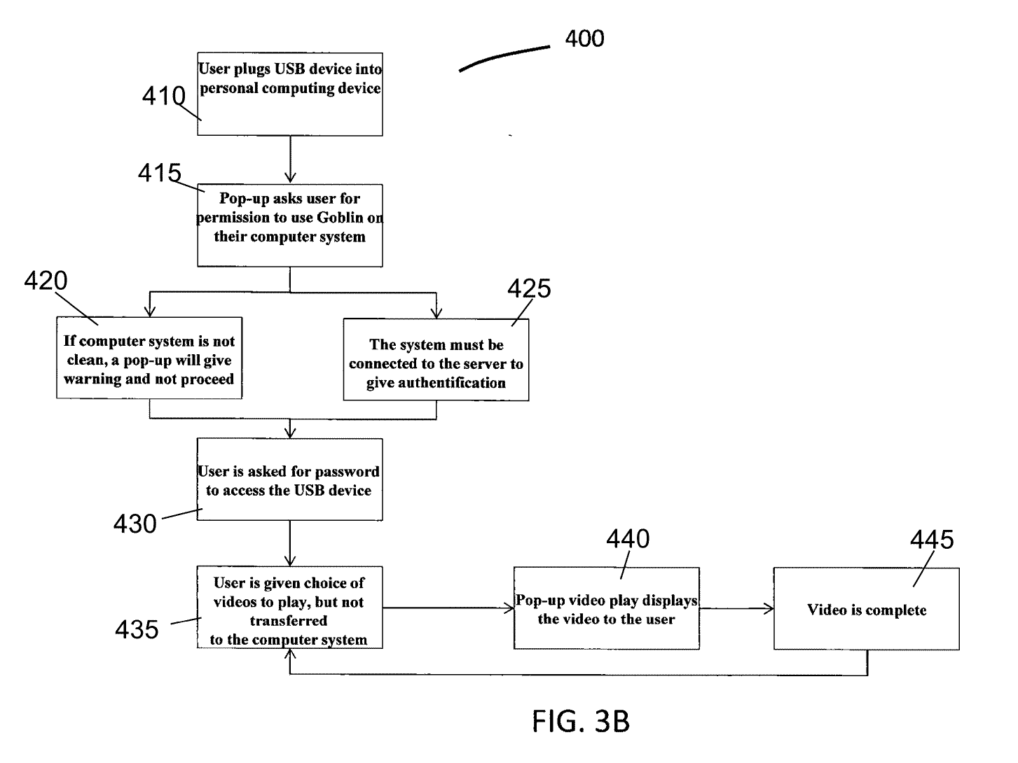

In some embodiments, one or more scout applications 101 will scan a computer system 30 to determine if it has been compromised (and hence unsafe to hold and protect digital content). For example, in some embodiments, a scout application 101 can perform a method comprising performing a security threat assessment of the hardware and software of the computing device (e.g., the computer system 30) using at least one processor 32 of the computing device to access and process one or more instructions of the one or more scout applications 101 to perform the steps of the method. For example, FIG. 3A shows a flow chart diagram illustrating system and method 300 performed by a scout application 101 within a hardware device in accordance with at least one embodiment of the invention. As shown, in some embodiments, a scout application 101 can determine that the computer system 30 has installed and recently run an approved antivirus and/or anti-malware program (step 310). In some further embodiments, the scout application 101 can determine if the computer system 30 has the most recent (i.e., up-to-date) virus definition files appropriate for the antivirus program that is approved and installed (in step 320). In some embodiments, the scout application 101 can determine whether or not viruses were detected on any most recent antivirus scans (in step 330). In some further embodiments of the system and method 300, a scout application 101 can verify that the applications on the computer system 30 which will run and/or play the digital content have not been modified (step 340).

In some embodiments of the system and method 300, the scout application 101 can verify that the applications on the computer system 30 which will run and/or play the digital content are the original and licensed versions (in step 350). In some embodiments of the system and method 300, a scout application 101 can verify that the operating system has not been modified (in step 360). Further, in some embodiments of the system and method 300, a scout application 101 can verify that the operating system has the most recent updates (in step 380).

In some other embodiments of the system and method 300, a scout application 101 can verify that no applications exist on the computer that would potentially compromise the digital content (in step 385). For example, in some embodiments, a scout application 101 can ascertain if digital content has been modified, or can be modified by one or more other software applications.

In some other embodiments of the system and method 300, a scout application 101 can proactively disable any malware that has been detected (in step 390). For example, in some embodiments, a scout application 101 can modify a malware application whereas in other embodiments, a scout application 101 can erase the malware application.

Some embodiments include a system and method to enable a user 41 to view at least one video based at least in part on one or more functions and/or actions of at least one scout application 101. For example, FIG. 3B shows a flow chart diagram illustrating user 41 implemented system operation method 400 performed by a scout application 101 within a hardware device (e.g., such as the computer system 30 and/or a user's computer 40) in accordance with at least one embodiment of the invention. As discussed earlier, in some embodiments, a scout application 101 can be uploaded to a non-transitory computer readable device such as a USB-type flash memory drive (or other external drive capable of being coupled and access by the user 41 device). In some embodiments, the external memory and/or drive device will also contain at least one video capable of being accessed as directed by the scout application 101. In some embodiments, once the external memory and/or drive is coupled to the user's device (e.g., such as the computer system 30, user computers 40, etc.,) in step 410, the external memory and/or drive can communicate to an external server through the device's internet connection. In some embodiments, the server will send the latest security information to the user 41 device prior to running the scout application 101. This embodiment enables the scout application 101 to be up-to-date with the latest threats, and also validates that the video player is uncorrupted. In some embodiments, a video can be securely viewed on the user's device using only an approved player. This prevents a trojan video player from grabbing and storing, copying, reproducing, or having access to the decrypted video.

In some embodiments, in step 415, a pop-up or other graphical communication can question the user 41 of their desire to run the scout application 101. For example, in some embodiments, after the external memory and/or drive is coupled with the user 41 device, a ‘yes’ or ‘no’ (or ‘proceed’ or ‘do not proceed’) question can be displayed to the user 41.

In some embodiments, if the scout application 101 determines the user 41 device is not clean (in step 420), a pop-up or other visual communication will display text or a symbol and/or color to warn the user 41 to not proceed. In some embodiments, the user 41 device must be connected to a conventional server (for example a Goblin scout server) to give authentication (illustrated in step 425).

In some embodiments, a user 41 can be asked for a password to access the external memory and/or drive (in step 430). In some embodiments, following receipt of a matching password, a user 41 can be provided with a choice of videos to display on the user's device. In some embodiments, one or more video data is transferred to the user 41 device for display on the user's device; however the video is not stored on the user's device (in step 435).

In some embodiments, a video pop-up display can play the video to the user 41 (in step 440). In some other embodiments, the video can be displayed within a window or can be displayed as a full-screen video. In some embodiments, the user 41 can control the size of the video displayed to the user 41. In some embodiments, once a video has completed, the user 41 can be provided with a further choice of videos to display on the user 41 device (step 445 returning to steps 435, 440).

In some embodiments, the system and method 400 provides video play to a user 41 only if the user's system is clean (i.e., free from viruses or other malware). In some embodiments, the scout application 101 will detect the type of virus software (e.g., Norton™ Antivirus, McAfee® and Kaspersky Anti-virus software), and whether the user's virus definitions are up-to-date, and that a virus scan has been recently performed.

Norton™ Antivirus are U.S. registered trademarks of Symantec Corporation

McAfee® and the McAfee logo are registered trademarks or trademarks of McAfee, Inc. or its subsidiaries in the United States and other countries

As previously mentioned, some embodiments of the present invention can be practiced with various computer system 30 configurations including hand-held devices, microprocessor systems, microprocessor-based or programmable consumer electronics, minicomputers, mainframe computers and the like. The invention can also be practiced in distributed computing environments where tasks are performed by remote processing devices. The systems and methods of some embodiments can include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device. In some embodiments, the data associated with the systems and methods (e.g., associations, mappings, data input, data output, intermediate data results, final data results, etc.) can be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

Some embodiments include computer components, software modules, various functions, data stores and data structures described herein that can be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality can be located on a single user 41 device, such as a single computer or distributed across multiple computers depending upon the situation at hand.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

With the above embodiments in mind, it should be understood that the invention can employ various computer-implemented operations involving data stored in computer system 30. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. The invention can also be embodied as computer readable code on a computer readable medium. The computer readable medium can be any data storage device that can store data, which can thereafter be read by a computer system 30. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer system 30.

The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources. The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. A computer-implemented method of securing data transfer to a computing device, the method comprising:
using at least one processor of a computing device, accessing a secure data transfer module and performing a security threat assessment of the hardware and software of the computing device by performing steps comprising:
scanning for the presence of a security threat comprising the absence of antivirus software or the presence of unapproved antivirus software stored in a non-transitory computer-readable medium;
scanning for the presence of a security threat comprising out-of-date virus definitions within any one file associated with any approved antivirus software residing on the non-transitory computer-readable medium;
scanning for the presence of a security threat comprising a malicious software code residing on non-transitory computer-readable media coupled to the computing device;
scanning for the presence of security threat comprising an operating system of the computing device that has been modified or has not received recent operating system updates;
scanning for the presence of a security threat related to digital content; and
using at least one processor of the computing device, accessing a secure data transfer module to process a secure data transfer to the computing device in the absence of any identified security threats determined by the computer-implemented method.

2. The computer-implemented method of claim 1, wherein the malicious software code comprises at least one of a virus or malware.

3. The computer-implemented method of claim 1, wherein the malicious software code comprises potentially unsafe software.

4. The computer-implemented method of claim 1, wherein any identified malicious code is modified by the secure data transfer module using the at least one processor.

5. The computer-implemented method of claim 1, wherein any identified malicious code is erased by the secure data transfer module using the at least one processor.

6. The computer-implemented method of claim 3, wherein the potentially unsafe software comprises an operating system of the computing device.

7. The computer-implemented method of claim 3, wherein the potentially unsafe software comprises at least one software module accessible and operable by the at least one processor.

8. The computer-implemented method of claim 1, wherein the non-transitory computer-readable medium includes at least one of a hard-drive, a solid-state drive, a CD/DVD drive, a random-access-memory device, a remote device drive, or a cloud-based drive.

9. The computer-implemented method of claim 1, wherein the secure data transfer module is stored on a non-transitory storage medium.

10. The computer-implemented method of claim 7, wherein the secure data transfer module is uploaded to the computing device; and
wherein the secure data transfer module is run by the at least one processor of the computing device.

11. The computer-implemented method of claim 1, wherein the security threat related to digital content includes any applications that are potentially harmful to digital content.

12. The computer-implemented method of claim 1, wherein the security threat related to digital content includes a modified digital content within the computing device.

13. The computer-implemented method of claim 1, wherein the security threat related to digital content includes the computer device comprising at least one application configured to run and/or play unoriginal and unlicensed versions of the digital content.

14. The computer-implemented method of claim 1, wherein the secure data transfer includes at least one video.

15. The computer-implemented method of claim 14, wherein the secure data transfer module and the at least one video are accessed from the same device or location.

16. The computer-implemented method of claim 1, further comprising the at least one processor accessing a secure data transfer server prior to performing a security threat assessment or processing a secure data transfer to the computing device.

17. The computer-implemented method of claim 16, wherein the secure data transfer server transfers security threat information to the computing device and the secure data transfer module; and
wherein any video player controlled by the at least one processor is validated for display of information by the secure data transfer module.

18. The computer-implemented method of claim 14, wherein the secure data transfer module requests a password from the user to initiate the secure data transfer; and
wherein the secure data transfer comprises data decryption.

19. The computer-implemented method of claim 18, wherein the user is provided with a choice of data to be transferred after secure data transfer is initiated.

20. A removeable non-transitory computer-readable storage device for storing and executing files transferred from the removeable non-transitory computer-readable storage device to a computing device, the removeable non-transitory computer-readable storage device comprising:
a non-transitory computer-readable storage medium comprising instructions for providing a secure data transfer to a computing device, wherein the instructions, when executed by at least one processor of the device, configure the at least one processor to access a secure data transfer module and perform a security threat assessment of the hardware and software of the computing device by performing steps comprising:
scanning for the presence of a security threat comprising the absence of antivirus software or the presence of unapproved antivirus software stored in a non-transitory computer-readable medium;
scanning for the presence of a security threat comprising out-of-date virus definitions within any one file associated with any approved antivirus software residing on the non-transitory computer-readable medium;
scanning for the presence of a security threat comprising a malicious software code residing on non-transitory computer-readable media coupled to the computing device;
scanning for the presence of security threat comprising an operating system of the computing device that has been modified or has not received recent operating system updates;
scanning for the presence of a security threat related to digital content; and
using at least one processor of the computing device, accessing a secure data transfer module to process a secure data transfer to the computing device in the absence of any identified security threats determined by the steps of the security threat assessment.
